(19) United States
(12) Patent Application Publication
(10) Pub. No.: US 2002/0193978 A1
(43) Pub. Date: Dec. 19, 2002

(54) Electrical power system performance simulation

(76) Inventor: Christophe Soudier, Ann Arbor, MI (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/883,503

(22) Filed: Jun. 19, 2001

Related U.S. Application Data
(60) Provisional application No. 60/297,757, filed on Jun. 14, 2001.

(51) Int. Cl. G06F 17/50

(52) U.S. Cl. 703/18

(57) ABSTRACT

A computer program product for simulating the performance of an electrical power system. The computer program product consists of a computer-readable medium containing an electrical power system model module, an input module and a simulation engine. The electrical power system model module contains one or more electrical power system models consisting of interrelated blocks and connections. The blocks represent elements comprising electrical circuits, electromechanical devices, and measurement devices, and the relationships between said blocks and said connections in said model are read-only with respect to an end user. The input module is operable on a computer to allow an end user to specify at least one characteristic for at least one said block in said model. The simulation engine is operable on a computer to simulate the performance of an electrical power system represented by the model using the specified block characteristics.

### BACKGROUND OF THE INVENTION

1. Field of the Invention

The present invention relates generally to simulation. More particularly, the present invention relates to simulation of the performance of electrical power systems.

2. Description of the Related Art

Across disciplines such as economics, engineering, and environmental science, experts are skeptical of the sustainability of our current means of generating, distributing, and using electrical power. In response, both electrical power producers and consumers are contemplating alternatives to conventional electrical power grids. Implementation of distributed power generation has attracted substantial attention as one alternative.

In a typical distributed power generation configuration, a local source, such as a wind driven micro-turbine, a fuel cell, or a low-emission combustion engine/permanent magnet generator combination is connected to both an aggregate local load and the conventional power grid. When local load demand exceeds the local source supply, the remaining needed electrical power is drawn from the grid. When local supply exceeds local demand, excess power is distributed back to the grid.

Local sources, such as fuel cells, typically provide electrical power that must be conditioned before being supplied to a load or connected to a conventional power grid. Inverters and associate associated power electronics for control, along with transformers for voltage conversion, impedance matching, and isolation are typically used to condition locally generated power. FIG. 1 generally illustrates the relationship between a local source, a local load, the grid, and conditioning elements.

It is often desirable to evaluate the performance of an alternative electrical power system. Public utility companies understandably desire to control the nature of devices connected to the grid in order to maintain a quality of service, i.e. to prevent interruptions, limit transients, and maintain efficiency. Electrical power consumers, especially large industrial or institutional users, desire to maintain efficient use of electrical power.

One option for evaluating the performance of an alternative electrical power system is to install the system and collect empirical data through instrumentation. This option is typically impractical from cost, schedule, and performance perspectives. Reliance on manufacturer's specifications and static analysis is another option. However, such an approach typically does not provide a satisfactory level of confidence in the results.

Simulation using tools such as Simulink™ (an interactive computer program product for modeling, simulating, and analyzing dynamic systems) provide another option for evaluating the performance of an alternative electrical power system. This option mitigates the cost, schedule and performance drawbacks of collecting empirical data and produces results with a higher degree of confidence than static analysis. However, such sophisticated programs typically require a working knowledge of complex modeling and simulation techniques, along with fluency in the program itself and knowledge of the concepts of the problem domain under consideration, i.e., electrical power generation and distribution.

Considering these needs and drawbacks, it is desirable to provide a system and method that facilitates evaluation of electrical power systems containing alternate sources without the cost, schedule, and performance drawbacks associated with collection of data through empirical methods; with a higher degree of confidence in the results that that available through static analysis; and requiring less end user knowledge of details of sophisticated simulation software.

### SUMMARY OF THE INVENTION

A computer program product for simulating the performance of an electrical power system. The computer program product consists of a computer-readable medium containing an electrical power system model module, an input module and a simulation engine. The electrical power system model module contains one or more electrical power system models consisting of interrelated blocks and connections. The blocks represent elements comprising electrical circuits, electromechanical devices, and measurement devices, and the relationships between blocks and connections the model are read-only with respect to an end user. The input module is operable on a computer to allow an end user to specify at least one characteristic for at least one block the model. The simulation engine is operable on a computer to simulate the performance of an electrical power system represented by the model using the specified block characteristics.

### DESCRIPTION OF THE SEVERAL VIEWS OF THE DRAWINGS

FIG. 1 illustrates the relationship between a source, inverter module, transformer, load, and grid as represented in the models of the present invention.

FIG. 2 is a block diagram that illustrates a computer system upon which an embodiment of the present invention may be implemented.

FIG. 3 is a block diagram illustrating the combined grid and stand-alone electrical power system model underlying preferred embodiments of the present invention.

FIG. 4 is a block diagram illustrating the grid electrical power system model underlying preferred embodiments of the present invention.

FIG. 5 is a block diagram illustrating the stand-alone electrical power system model underlying preferred embodiments of the present invention.

FIG. 6 is an illustration of the link between various windows of a preferred embodiment of the present invention.

FIG. 7 is an illustration of a configuration choice window of the present invention.

FIG. 8 is an illustration of a principle window of the present invention.

FIG. 9a is an illustration of a source setting window of the present invention.

FIG. 9b is an illustration of a source details window of the present invention.

FIG. 10 is an illustration of an inverter setting window of the present invention.

FIG. 11 is an illustration of a transformer setting window of the present invention.

FIG. 12 is an illustration of a grid setting window of the present invention.

FIG. 13 is an illustration of a load setting window of the present invention.

FIG. 14 is an illustration of a motor setting window of the present invention.

FIG. 15 is an illustration of a motor fault setting window of the present invention as an example of a general fault setting window of the present invention.

FIG. 16 is an illustration of a motor isolation contactor window of the present invention as an example of a general switch/breaker/contactor setting window of the present invention.

FIG. 17 is an illustration of a simulation window of the present invention.

FIGS. 18 and 19 are illustrations of scope windows of the present invention.

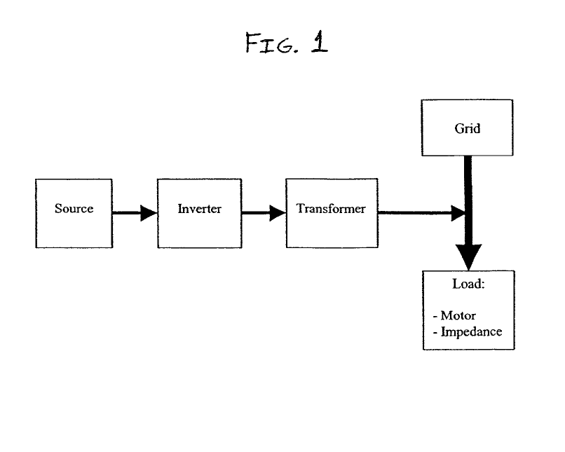

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

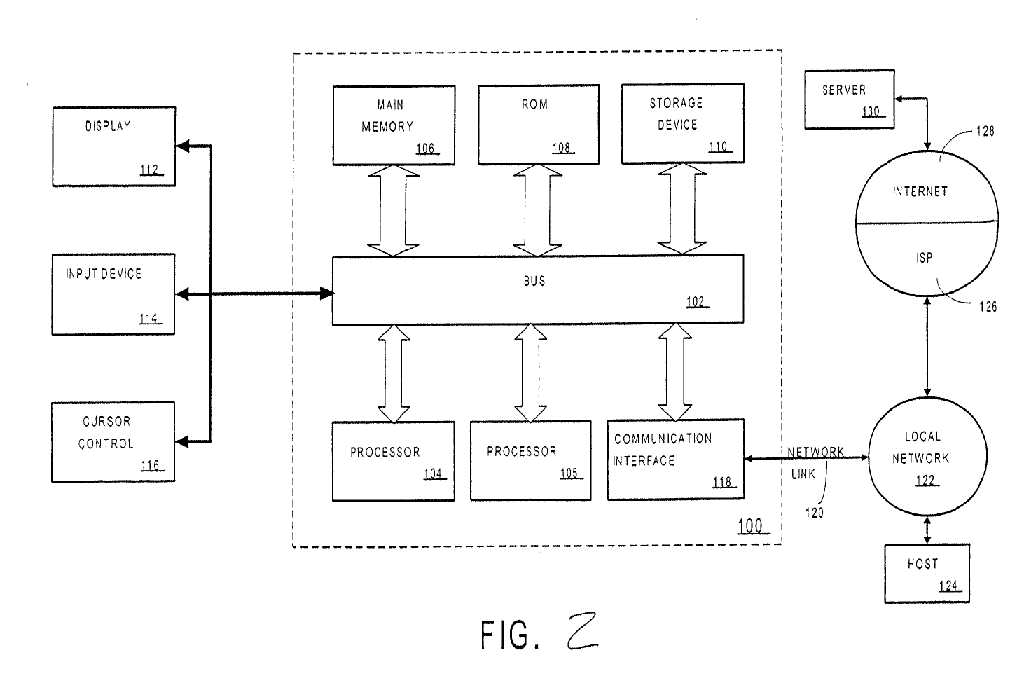

FIG. 2 is a block diagram that illustrates a computer system 100 upon which an embodiment of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other volatile storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other non-volatile storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor104 and for controlling cursor movement on display 112. This input device typically has two degrees of freedom in two axes, a first axis (e.g., x) and a second axis (e.g., y), that allows the device top specify positions in a plane.

One embodiment of the invention is related to the use of computer system 100 for simulating the performance of an electrical power system containing a non-grid source, e.g., fuel cells, or a turbine generator. According to one embodiment of the invention, simulation is provided by computer 100 in response to processor 104 executing one or more sequences of one or more instructions contained in main memory 106. Such instructions may be read into main memory 106 from another computer readable medium, such as a storage device 110. Execution of the sequences of instructions contained in main memory 106 causes processor 104 to perform the process steps described herein. One or more processors in a multi-processing arrangement may also be employed to execute the sequences of instructions contained in main memory 106. In alternative embodiments, hardwired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media include, for example, optical or magnetic disks, such as storage device 110. Volatile media include dynamic memory, such as main memory 106. Transmission media include coaxial cables, copper wire and fiber optics, including the wires that comprise bus 102. Transmission media can also take the form of acoustic or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium, with patterns of holes, a RAM, a PROM (programmable ROM), and EPROM (electronically PROM) a FLASH-EPROM, any other memory chip or cartridge, a carrier wave, or any other medium from which a computer can read.

Various forms of computer-readable media may be involved in carrying one or more sequences of one or more instructions to processor 104 for execution. For example, the instructions may initially be borne on a magnetic disk of a remote computer. The remote computer can load instructions into its dynamic memory and send the instructions over a telephone line using a modem. A modem local to computer system 100 can receive the data on the telephone line and use an infrared transmitter to convert the data to an infrared signal. An infrared detector coupled to bus 102 can receive the data carried in the infrared signal and place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, radio frequency, or optical signals that carry digital streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the worldwide packet data communication network, now commonly referred to as the Internet 128. Local network 122 and Internet 128 both use electrical, radio frequency, or optical carriers to carry data streams. The signals through the various networks and the signals on the network link 120 and through communication interface 118, which carry the data to and from computer system 100, are exemplary forms of carrier waves transporting the information.

Computer system 100 can send messages and receive data, including program code, through the network(s), network link 120, and communication interface 118. In the Internet example, a server 130 might transmit a requested code for an application program through Internet 128, ISP 126, local network 122, and communication interface 118. In accordance with the invention, one such downloaded application provides for simulation of the performance of an electrical power system as described herein. The received code may be executed by processor 104 as it is received, and/or stored in a storage device 110, or other non-volatile storage for later execution. In alternative embodiments of the invention only that portion of the instructions necessary to interface the computer system 100 to the server 130 or host 124 is downloaded to the computer system, i.e., in an Internet Application Server Provider (ASP) configuration, or a thin-client configuration.

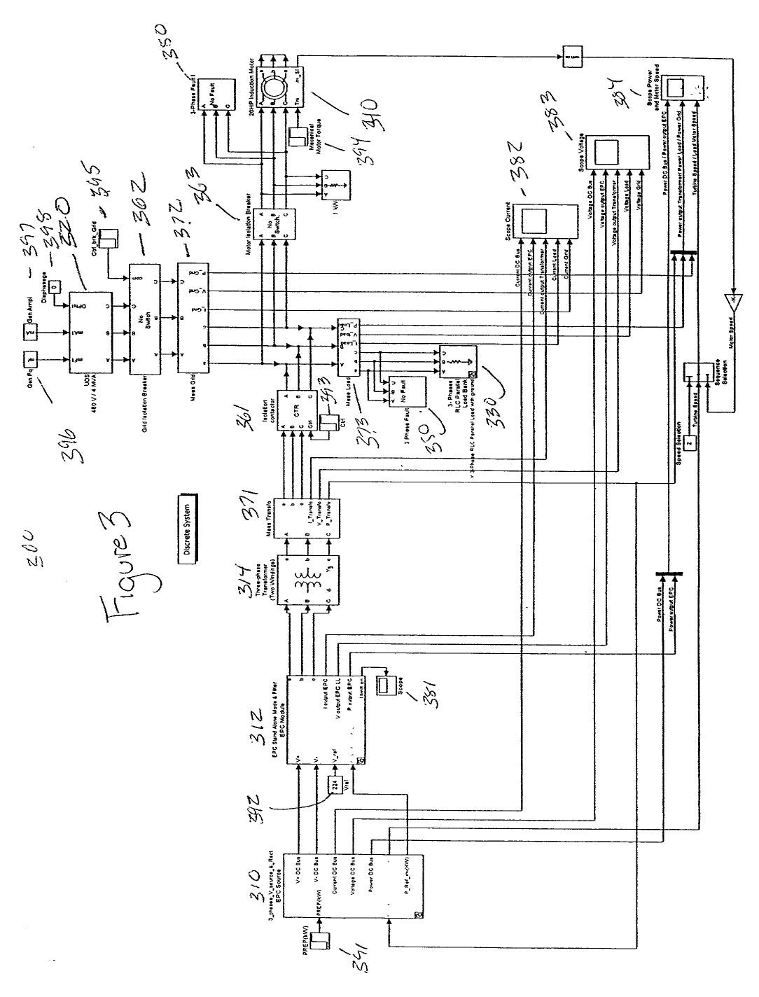

Referring to FIG. 3a, an electrical power system model topology 300 built in Simulink™ using basic blocks, configurable subsystems, and elements from Simulink™ power system blockset is shown. A description of those properties salient to the present invention follows.

A block represents an elementary dynamic system; it includes one or more of the following: a set of inputs, a set of states, and a set of outputs. Each output is a function of time, the associated inputs, and the states of the block. The specific function that relates a block's output to its inputs, states, and time depends on the type of the block. A block in a model is a specific instance of a block type.

In general, Simulink™ configurable subsystems enable a user to define a block to represent any one of a plurality of blocks contained in a specified library. A dialog box allows the user to specify a particular block and values of the parameters of the specified block. In the present invention, an end user (as distinguished form a user with access to the underlying model topology) will not have access to the Simulink™ dialog box, but will be restricted to choosing a preformatted block and adjusting parameters within fixed ranges. The Simulink™ power blockset contains pre-configured blocks representing common components and devices found in electrical power networks.

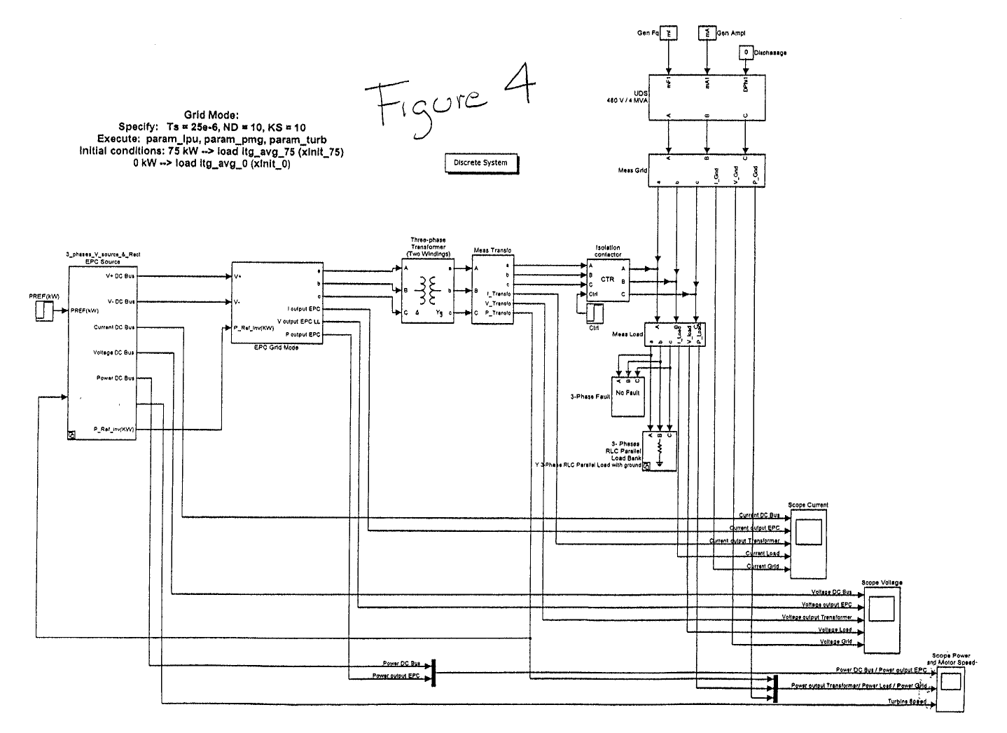

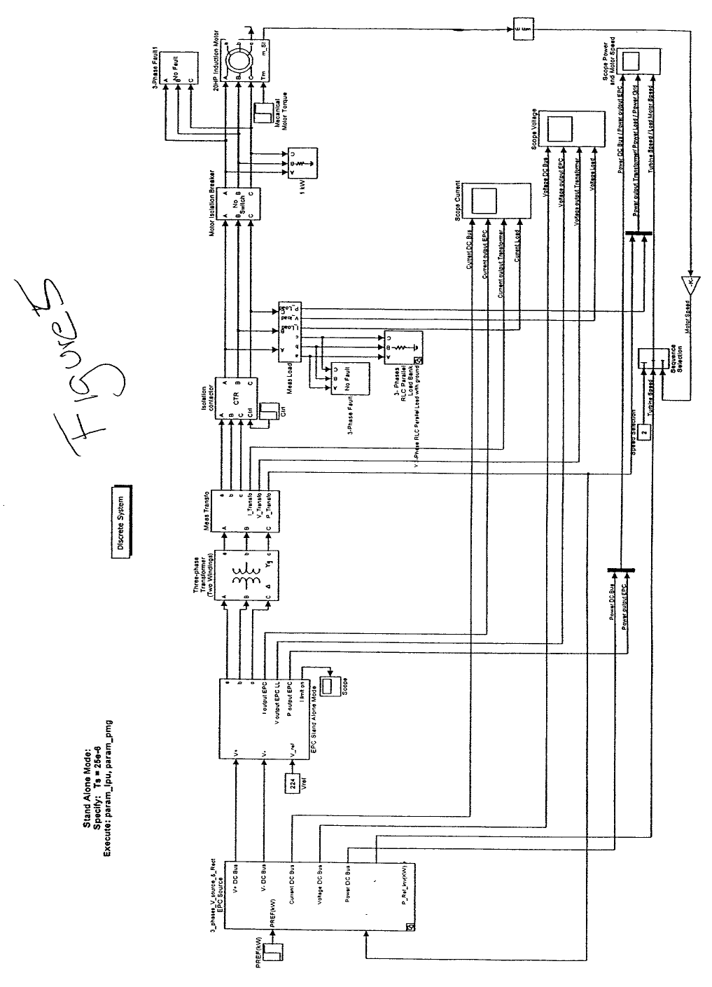

Preferred embodiments of the present invention offer an end-user the choice of one of three models: a combined model 300 as illustrated in FIG. 3; a stand-alone model 400 as illustrated in FIG. 4; and a grid-only model 500 as illustrated in FIG. 5. The combined mode will also be referred to as the “grid & stand alone” mode. The stand-alone model 400 and grid-only model 500 are subsets of the combined model 300. As such, the following description addressing the combined model 300 also applies to the stand-alone model 400 and the grid-only model where those models contain elements found in the combined model 300.

The combined model 300, illustrated in FIG. 3, contains the following blocks: source 310; inverter module 312; transformer 314; grid 320; load 330; motor 340; various fault blocks 350 (for simulating a fault at various points in the modeled system); various isolation switches, circuit breakers, and contactors i.e., source isolation contactor 361, grid isolation breaker 362, motor isolation breaker 363; and various measurement blocks, i.e., transformer measurement block 371, grid measurement block 371, and load measurement block 373; various scopes, i.e., general scope 381, current scope 382, voltage scope 383, power and motor speed scope 384; various input blocks, i.e., source preference block 391, voltage reference block 392, isolation contactor block 393, mechanical torque block 394, grid control block 395, grid frequency block 396, grid amplitude block 397, and grid disphasage block 398

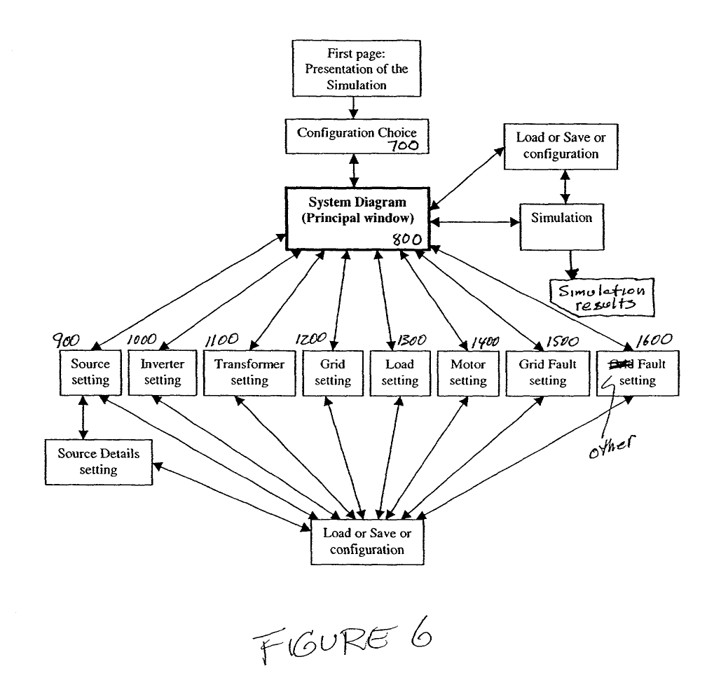

FIG. 6 illustrates one possible set of relationships between those windows available to an end user through the display 102. Each window and the functionality it provides will now be described.

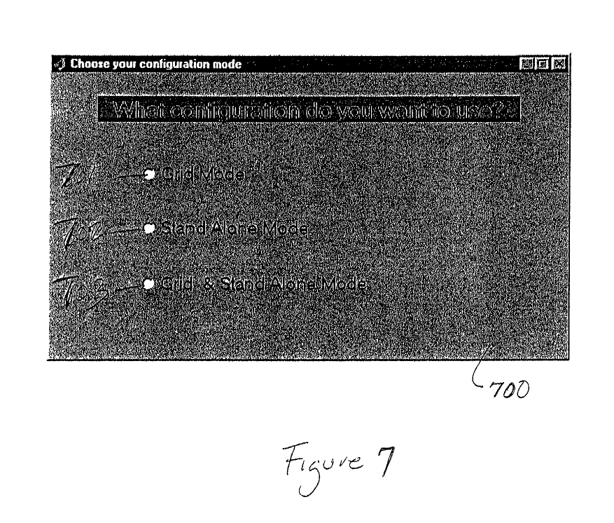

In the present invention one or more electrical power system models are created and stored on computer-readable media. In preferred embodiments of the present invention, three models (combined 300, stand-alone 400, and grid-only 500) are built from interrelated blocks and connections. These models are not accessible to an end user. Instead, the invention prompts an end user, through an input module configuration choice window 700, to select one of the three model configurations for simulation as illustrated in FIG. 7. An end user may select a particular model configuration by selecting the radiobutton 701, 702, 703 most proximate to the title of the desired model configuration.

The M-file associated with window 700 includes the following instructions

Launch

Open the figure

Callbacks

Radiobutton1:

Open the associated model: epc_model_grid_alone.mdl

Set the variable “modechoice” to “grid”

Open the Principal window

Radiobutton2:

Open the associated model: epc_model_SA_alone.mdl

Set the variable “modechoice” to “SA”

Open the Principal window

Radiobutton3:

Open the associated model: epc_model.mdl

Set the variable “modechoice” to “GridSA”

Open the Principal window

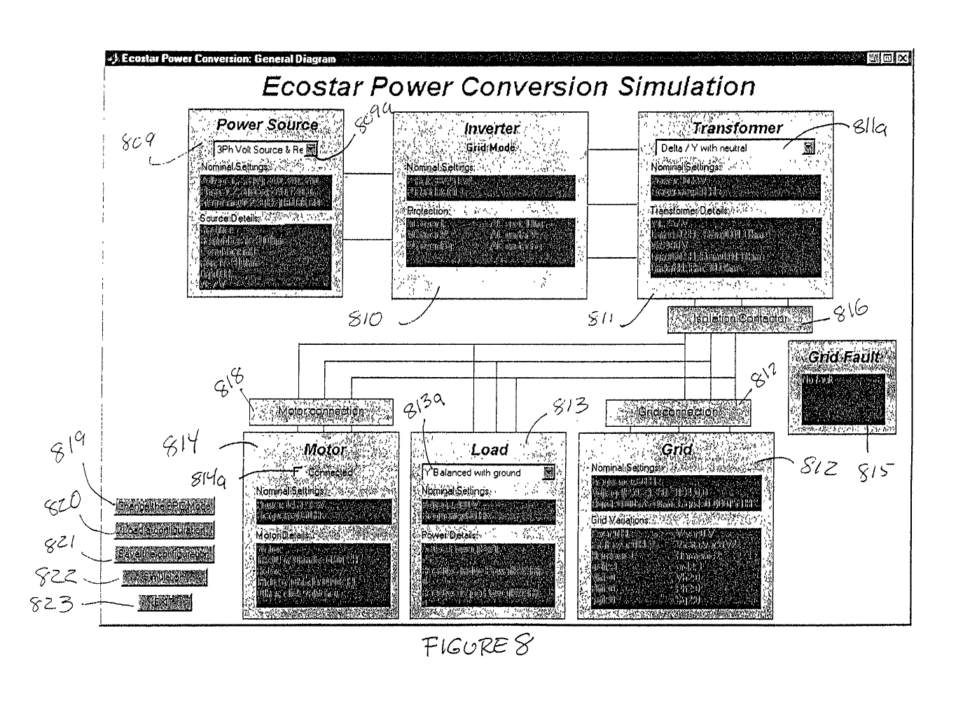

FIG. 8 illustrates the principal window 800 of preferred embodiments of the present invention. The principal window 800 provides an end user with a summary view of current simulation parameters. Key model blocks are represented as subwindows, some including pull-down menus or checkboxes as indicated in FIG. 8 and described herein.

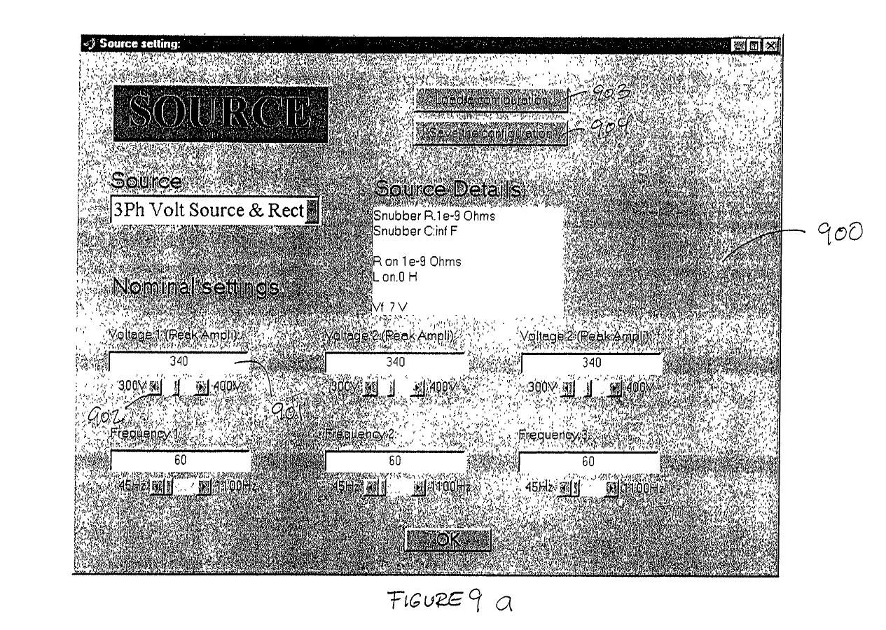

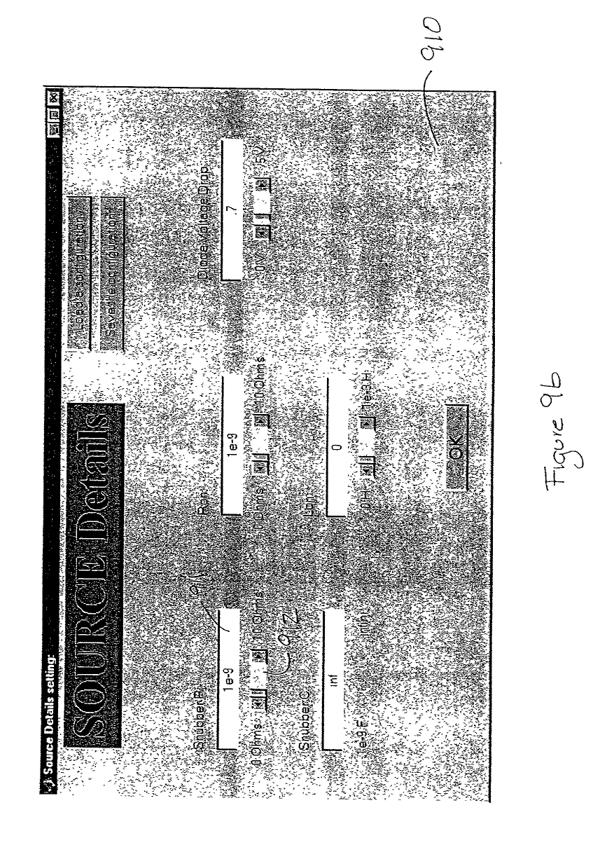

The power source subwindow 809 contains a pull-down menu 809a for selecting one power source from among those sources available in the power source configurable subsystem block 310. In the preferred embodiment, power source choices include a direct current (DC) source, a 3-phase alternating current (AC) source and rectifier, a permanent magnet generator (PMG) and rectifier, and a turbine linked to a PMG and rectifier. The power source subwindow 809 also contains a summary of the current parameter values for the currently selected power source subsystem. Selecting within the power source subwindow 809, e.g., by using the input device 114 or cursor control 116 will open the source setting window 900 illustrated in FIG. 9a and described below. Selection is accomplished typically by right clicking on the text zone.

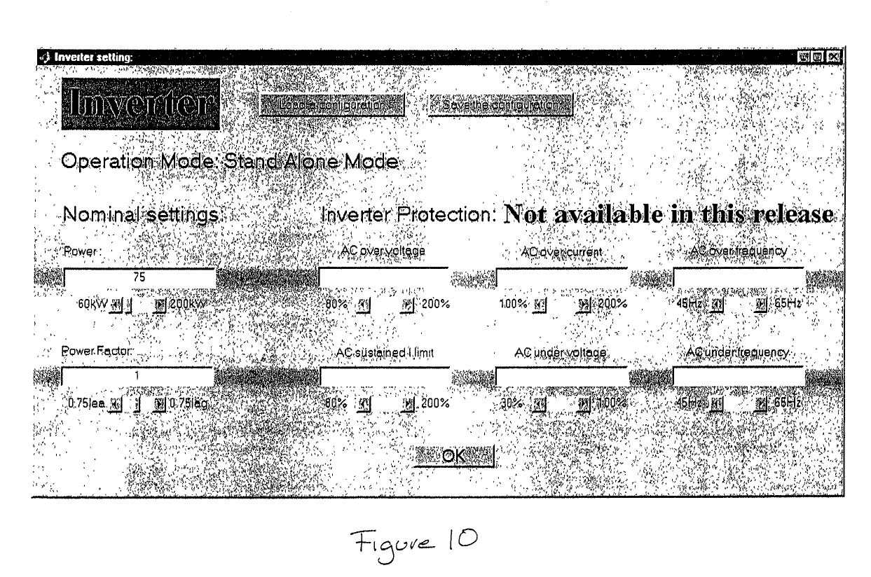

The inverter module subwindow 810 contains a summary of the current parameter values for the inverter module configurable subsystem block 312. Selecting within the inverter module subwindow 810, e.g., by using the input device 114 or cursor control 116 will open the inverter setting window 1000 illustrated in FIG. 10 and described below.

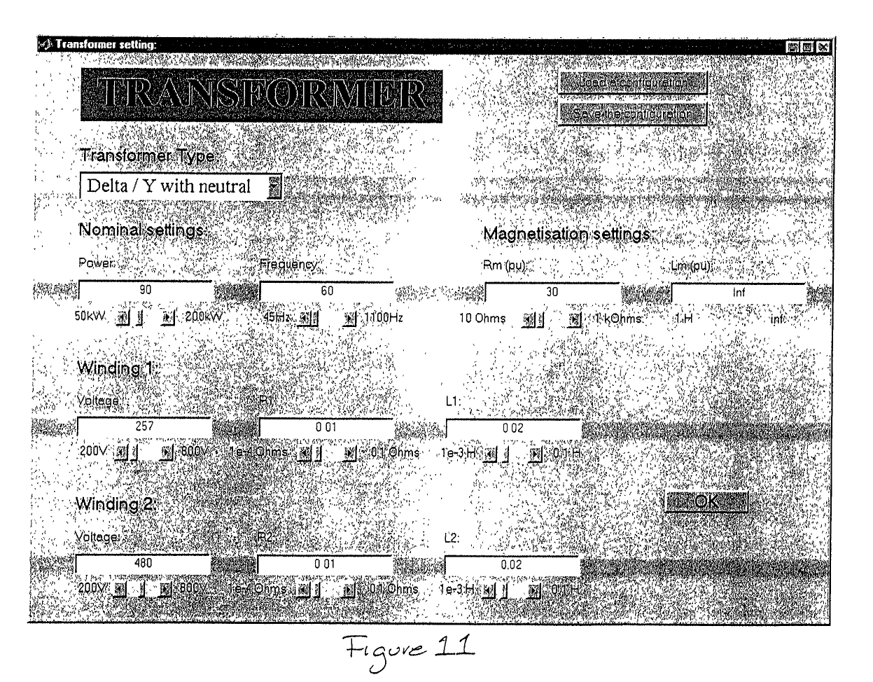

The transformer subwindow 811 contains a pull-down menu 811a for selecting transformer from among those sources available in the transformer configurable subsystem block 314. In the preferred embodiment, transformer choices include combinations of delta, Y, and Y with neutral. The transformer subwindow 811 also contains a summary of the current parameter values for the currently selected transformer. Selecting within the transformer subwindow 811, e.g., by using the input device 114 or cursor control 116 will open the transformer setting window 1100 illustrated in FIG. 11 and described below.

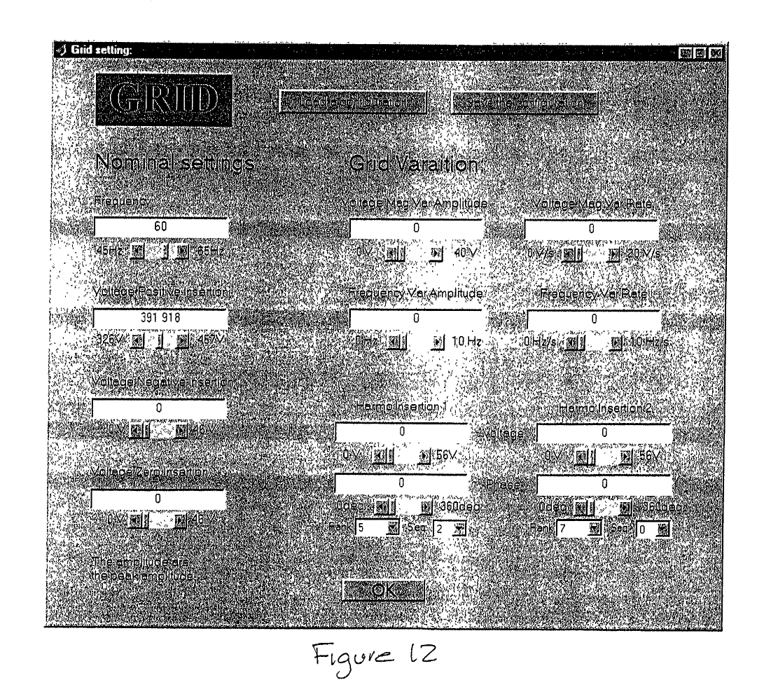

The grid subwindow 812 contains a summary of the current parameter values for the grid block 320. Selecting within the grid subwindow 812, e.g., by using the input device 114 or cursor control 116 will open the grid setting window 1200 illustrated in FIG. 12 and described below.

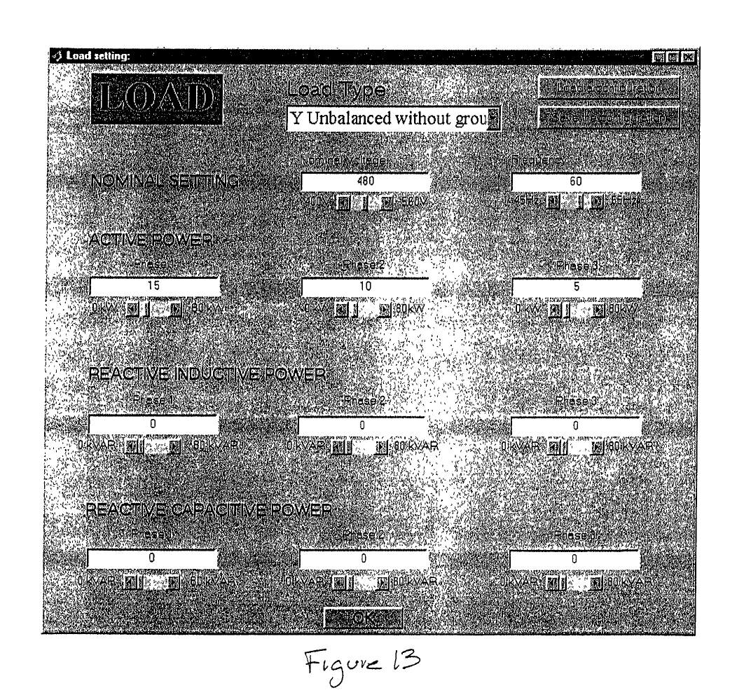

The load subwindow 813 contains a pull-down menu 813a for selecting load configuration from among those load configurations available in the load configurable subsystem block 330. In the preferred embodiment, load choices include Y without ground, Y with ground, Delta. The load subwindow 813 also contains a summary of the current parameter values for the currently selected transformer. Selecting within the load subwindow 813, e.g., by using the input device 114 or cursor control 116 will open the load setting window 1300 illustrated in FIG. 13 and described below.

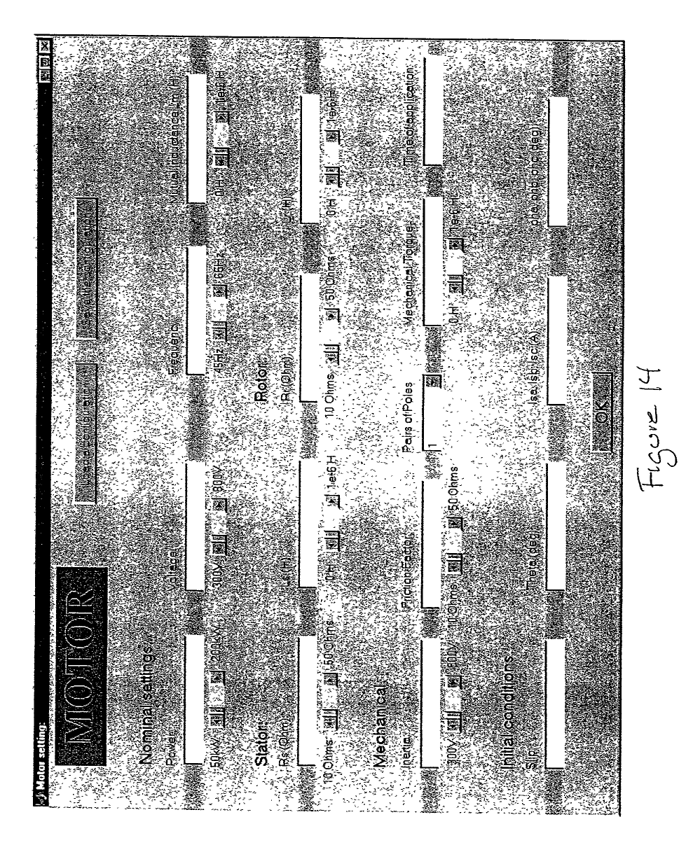

The motor subwindow 814 contains a summary of the current parameter values for the motor block 340. The motor subwindow 814 also contains a checkbox 814a for connecting or disconnecting the motor block 340. Selecting within the motor subwindow 814, e.g., by using the input device 114 or cursor control 116 will open the motor setting window 1400 illustrated in FIG. 14 and described below.

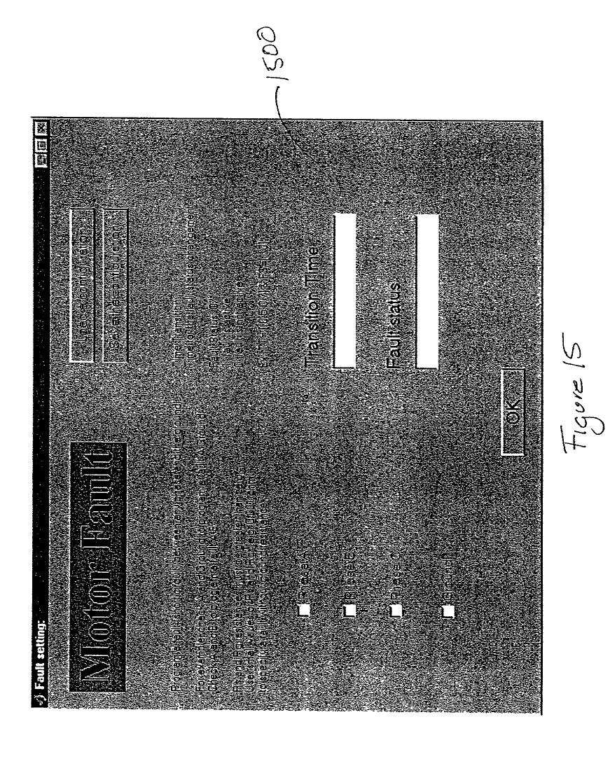

The grid fault subwindow 815 contains a summary of the current parameter values for the grid fault block 350. Selecting within the grid fault subwindow 815, e.g., by using the input device 114 or cursor control 116 will open the grid fault setting window 1500 illustrated in FIG. 15 and described below. Similar fault subwindows may also represent other fault blocks.

Subwindows representing isolation switches (window 816), grid breakers (window 817), and motor circuit breakers (window 818) are also included in the principal window 800. Selecting within any of these windows, e.g., by using the input device 114 or cursor control 116 will open the appropriate setting window for control of switch, breaker, or contact control as known in the art.

In addition, principal window 800 allows an end user several control choices leading to other interactive windows. An end user may return to the configuration choice window 700 by selecting the “Change the EPC Mode” pushbutton 819. An end user may invoke a window to load a previously saved configuration by selecting the “Load a configuration” pushbutton 820. An end user may invoke a window to save the current configuration by selecting the “Save the configuration” pushbutton 821. The illustrated embodiment allows an end user to proceed directly to a simulation window by selecting the “Simulation” pushbutton 822, or to exit the program by selecting the “Exit” pushbutton 823.

The M-file associated with window 800 and it subwindows includes the following instructions:

Launch

Open the figure

Set the parameter text, Popup menu and the visibility for each block:

Source

Inverter

Transformer

Grid

Load

Motor

Callbacks

For the Source block:

Popupmenu (SourceMenu):

Change the block in the model according to the new choice

Set the parameters values in the Text uicontrol according to the block choice (setstring.m)

Open the Source setting window (fig_source_model.m)

StaticText (SourceText1 or SourceText2): buttonDownFunction

Open the Source setting window (fig_source_model.m)

For the Inverter block:

StaticText (InverterText1 or InverterText2(later)): buttonDownFunction

Open the Inverter setting window (fig_EPC_model.m)

StaticText (InvertText2): buttonDownFunction

Open a message box: Protection not available for this version

For the Transformer block:

Popupmenu (TransfoMenu):

Change the widding parameter in the model according to the new choice

Set the parameters values in the Text uicontrol according to the block choice (setstring.m)

Open the Transformer setting window (fig_transfo_model.m)

StaticText (TransfoText1 or TransfoText2): buttonDownFunction

Open the Transformer setting window (fig_transfo_model.m)

For the Grid block: (if Grid Mode or Grid & SA Mode)

StaticText (GridText1 or GridText2): buttonDownFunction

Open the Grid setting window (fig_grid_model.m)

For the Load block:

Popupmenu (LoadMenu):

Change the block in the model according to the new choice

Set the parameters values in the Text uicontrol according to the block choice (setstring.m)

Open the Load setting window (fig_load_model.m)

StaticText (LoadText1 or LoadText2): buttonDownFunction

Open the Load setting window (fig_load_model.m)

For the Motor Block:

Popupmenu (MotorMenu):

Change the block in the model according to the new choice

Set the parameters values in the Text uicontrol according to the block choice (setstring.m)

Open the Motor setting window (fig_motor_model.m)

StaticText (MotorText1 or MotorText2): buttonDownFunction

Open the Motor setting window (fig_motor_model.m)

For the Fault blocks:

StaticText (FaultLoad(or Grid)1):

Set the parameter “faultchoice”

Open the Fault setting window (fig_fault_model.m)

For the Contactor Isolation or Motor Connection or Grid connection block (when they are visible):

StaticText

Set the parameter “breakerchoice”

Open the Breaker setting window (fig_breaker_model.m)

Others:

Pushbutton1 (Change the mode):

Open a message box to warn the user he will lose his setting and ask me if he wants to save them

Close the current model

Open the “fig_choice_mode” window (fig_choice_mode.m)

Pushbutton2 (Load a configuration):

Open the dialog window with the arguments: pos and load_file (filedlg.m)

Pushbutton3 (Save a configuration):

Open the dialog window with the arguments: pos and save_file (filedlg.m)

Pushbutton4 (Simulation):

Open the Simulation window with the arguments: pos and load_file (filedlg.m)

The source setting window 900, illustrated in FIG. 9a, allows a user to set a variety of source parameters by direct text entry, e.g., editbox 901 or through use of a slider bar 902. The user may also save the current configuration or load a saved configuration at this and subsequent windows by selecting the appropriate button e.g., 903, 904. Upon selecting “Load a configuration,” e.g., 903 or “Save the configuration,” e.g., 904, the user is prompted for file information regarding the configuration to be loaded or saved. Selecting within the source setting window 900 is by using the input device 114 or cursor control 116. The M-file associated with window 900 includes the following instructions.

Launch

Open the figure

Set the Popupmenu according to the block choice in the model

Set the text, the EditBox and the slider, the visibility for each group according to the source choice and the parameter value (SetEditBox.m):

Voltage: Amplitude (V) or Peak Amplitude, Speed Reference, Power Reference

Frequency

Callbacks

Pushbutton1 (Load a configuration):

Open the dialog window with the arguments: pos and load_file (filedlg.m)

Pushbutton2 (Save a configuration):

Open the dialog window with the arguments: pos and save_file (filedlg.m)

Pushbutton3 (OK):

Validation that sets the model parameters.

Load the block choice

Set the model parameters according to the block choice (epc_model_*.mdl)

Set the parameters values in the Text uicontrol in the principal window according to the block choice (setstring.m)

Close the modification window

Popupmenu:

Change the block in the model according to the new choice

Set the parameters values in the Text uicontrol (setstring.m)

Set the parameters values in the Edit Box and the Sliders according to the block choice (SetEditBox.m)

Edit box and sliders:

the same approach for the 2 groups:

Edit box:

Test if the values input is valid: numeric and not out of range

According to the test:

Yes: set the slider

No: Error Dialog Box

Slider:

Set the Edit Box value according to the slider value

The source details window 910, illustrated in FIG. 9b, allows a user to set further source details, again, by use of direct text entry, e.g., editbox 911 or through use of a slider bar 912. The M-file associated with window 910 includes the following instructions.

Launch

Open the figure

Set the text, the EditBox and the slider for each group according the parameter value (SetEditBox.m)

Callbacks

Pushbutton1 (Load . . . ), 2 (Save . . . ), 3 (OK):

See fig_source_model

EditBox and Slider (the 5 groups)

See fig_source_model

The inverter setting window (FIG. 10, 1000), transformer setting window (FIG. 11, 1100), grid setting window (FIG. 12, 1200), load setting window (FIG. 13, 1300), and motor setting window (FIG. 14, 1400) each operate in a similar fashion. The M-files associated with these windows contains the following code.

Inverter Settings

Launch

Open the figure

Set the text, the EditBox and the slider for each group according the parameter value and the block choice (SetEditBox.m)

Callbacks

Pushbutton1 (Load . . . ), 2 (Save . . . ), 3 (OK):

See fig_source_model

EditBox and Slider (the 8 groups)

See fig_source_model

Transformer settings

Launch

Open the figure

Set the text, the EditBox and the slider for each group according the parameter value and the block choice (SetEditBox.m)

Callbacks

Pushbutton1 (Load . . . ), 2 (Save . . . ), 3 (OK):

See fig_source_model

EditBox and Slider (the 10 groups)

See fig_source_model

Popupmenu:

See fig_source_model

Here, it's not a block choice to change, but 2 parameters to set: connection for winding 1 & 2

Grid Settings

Launch

Open the figure

Set the text, the EditBox and the slider for each group according the parameter value (SetEditBox.m)

Callbacks

Pushbutton1 (Load . . . ), 2 (Save . . . ), 3 (OK):

See fig_source_model

EditBox and Slider (the 12 groups)

See fig_source_model

Popupmenu (rank and sequence):

No callback because the parameters values are set in the model when the use press the OK

Load Settings

Launch

Open the figure

Set the text, the EditBox, the slider and the visibility for each group according the parameter value and the block choice (SetEditBox.m)

Callbacks

Pushbutton1 (Load . . . ), 2 (Save . . . ), 3 (OK):

See fig_source_model

EditBox and Slider (the 5 groups)

See fig_source_model

Popupmenu:

See fig_source_model

Motor Settings

Launch

Open the figure

Set the text, the EditBox and the slider for each group according the parameter value (SetEditBox.m)

Callbacks

Pushbutton1 (Load . . . ), 2 (Save . . . ), 3 (OK):

See fig_source_model

EditBox and Slider (the 11 groups)

See fig_source_model

EditBox alone (5):

Check if the string is valid: numeric, good format, out of range?

FIG. 15 is a motor fault window 1500, illustrative of fault windows of the present invention in general. Through that window 1500, an end user may select the specific phase or ground into which to introduce a fault. An end user may also indicate the transition time from active to not active fault status. The M-file associated with this window contains the following code.

Launch

Open the figure

Set the title text, the EditBox and the checkbox according the parameter value (SetEditBox.m)

Callbacks

Pushbutton1 (Load . . . ),2 (Save . . . ), 3 (OK):

See fig_source_model

Checkbox 1,2,3,4:

No callback because the parameters values are set in the model when the use press the OK

EditBox 1, 2:

Check if the string is valid: numeric, good format, out of range?

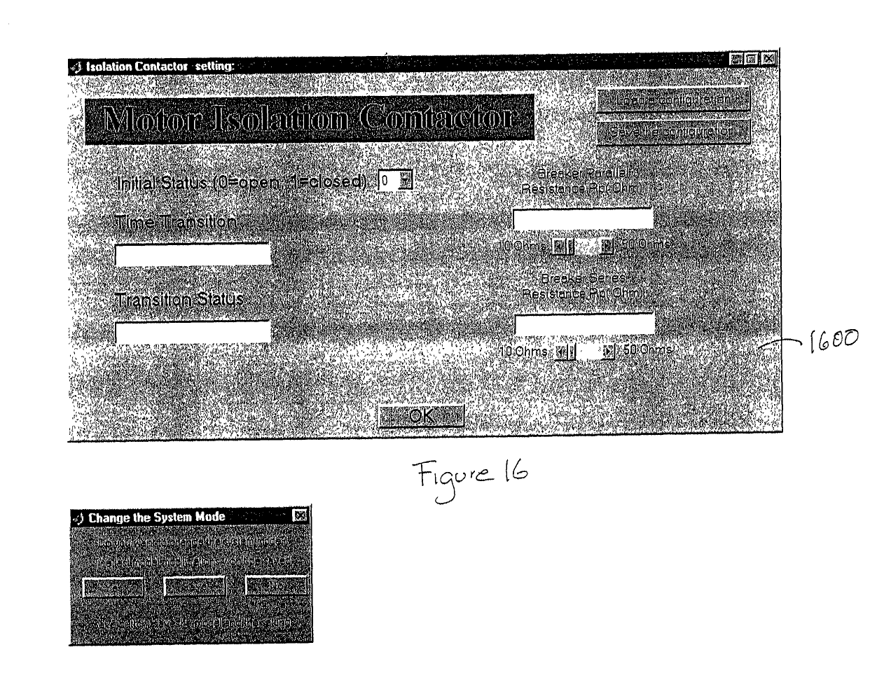

FIG. 16 is a motor isolation contactor window 1600, illustrative of contactor, isolation switch, and circuit breaker windows of the present invention in general. Through that window 1600, an end user may select the characteristics of a contactor 361 or breaker 362, 363. The M-file associated with this window contains the following code

Launch

Open the figure

Set the title text, the EditBox and the sliders according the parameter value (SetEditBox.m)

Callbacks

Pushbutton1 (Load . . . ) 2 (Save . . . ) 3 (OK):

See fig_source_model

EditBox 1, 2:

Check if the string is valid: numeric, good format, out of range?

EditBox and Slider (the 2 groups)

See fig_source_model

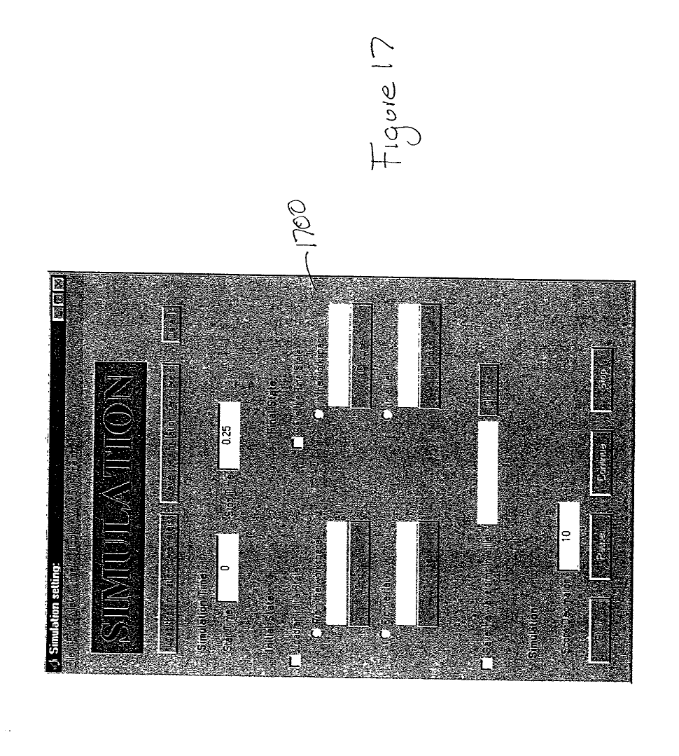

Typically, after loading saved settings or entering settings through the previously described windows, an end user may invoke the simulation window 1700, illustrated in FIG. 17. The Simulation window, through a combination of checkboxes and editboxes employed in the fashion describe above and illustrated in FIG. 17, offers an end user the opportunity to set simulation start and stop times, load an initial state for the system (typically a previously saved final state), and save output waveforms to a file. The M-file associated with this window contains the following instructions.

Launch

Open the figure

Callbacks

Pushbutton1 (Load . . . ), 2 (Save . . . ):

See fig_source_model

EditBox 1, 2:

Check if the string is valid: numeric, good format, out of range?

Checkbox:

If selected, one Radio button must be activated

If a Radio button is selected the associated checkbox is activated

Radio buttons:

Create a link between them: only one can be selected in each category: Initial and final State

Toggle buttons:

When you start a simulation, the buttons represent the simulation state

Before beginning a simulation:

Star button is up and enable.

Pause button is up and disable

Continue button is up and disable

Stop button is up and disable

When the simulation is running:

Star button is pushed and disable.

Pause button is up and enable

Continue button is up and disable

Stop button is up and enable

When you do a pause:

Star button is pushed and disable.

Pause button is pushed and disable

Continue button is up and enable

Stop button is up and enable

When you continue: same state than for running

When the simulation stop: same state than before running

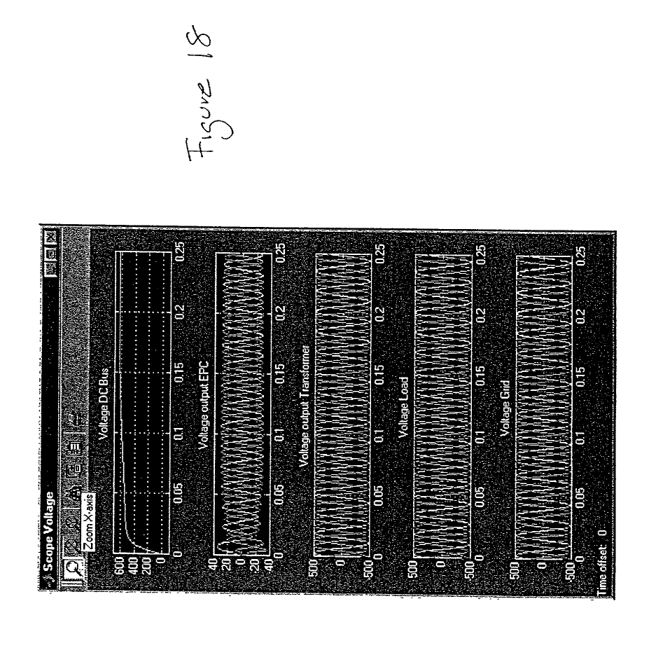

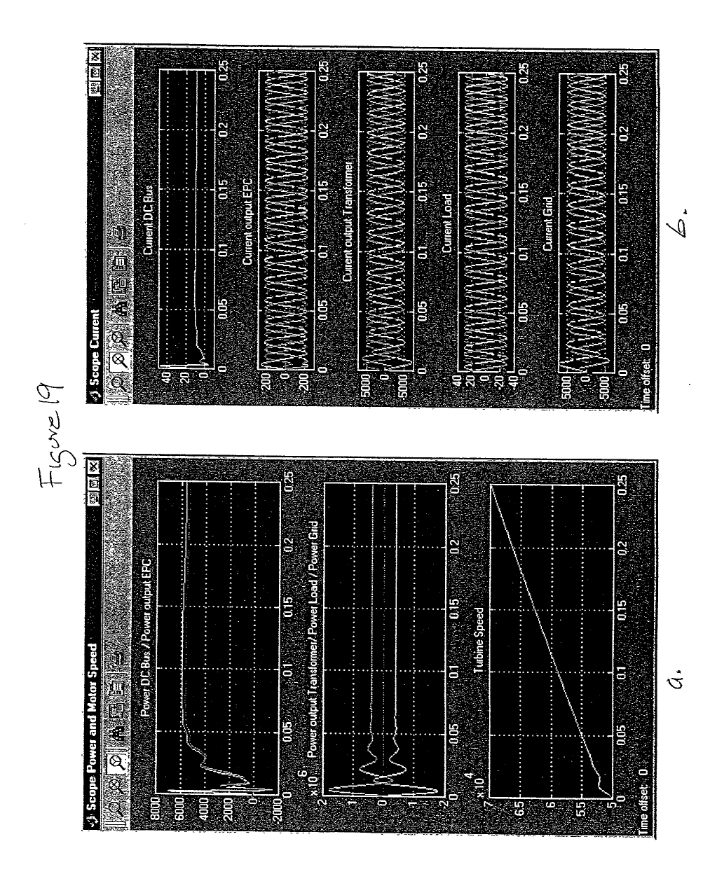

Simulation output may be saved to a file in main memory 106 or on a storage device 110 for later plotting, or displayed to a display 112 in the manner depicted in FIGS. 18 and 19.

The output illustrated in FIG. 18 is compiled from simulation voltage data collected at the model point corresponding to scope voltage 383 in FIG. 3. The voltages monitored by the illustrated preferred embodiment include the DC voltage generated by the EPC source310, the 3-phase AC voltage output by the inverter module 312, the 3-phase voltage at the transformer 314 output, the 3-phase voltage at the load 330, and the 3-phase voltage supplied at the grid 320. For multiphase AC voltages (as well as multiphase AC currents), the values plotted for each phase are in different colors readily distinguishable from each other. The output illustrated in FIG. 19b are the corresponding current measurements through the same points in the circuit at which voltage is measure in FIG. 18.

FIG. 19a illustrates the systems ability to output simulation results for power. The top scope compares the power at the output of the inverter module 312 to the power at the input of the inverter module 312. The middle scope compares power at the output of the transformer 314 to the power consumed by the load 330 and the power supplied by the grid 320. Finally, the bottom scope compares the selected motor speed with the simulated motor speed and the turbine speed.

Illustrative embodiments of unique systems and methods for evaluating the performance of electrical power systems have been described herein. These and other variations, which will be appreciated by those skilled in the art, are within the intended scope of this invention as claimed below. As previously stated, detailed embodiments of the present invention are disclosed herein; however, it is to be understood that the disclosed embodiments are merely exemplary of the invention that may be embodied.

1. A computer program product for simulating the performance of an electrical power system, said computer program product comprising:
a computer-readable medium;
an electrical power system model module:
stored on said computer readable medium, and
comprising an electrical power system model, said model comprising interrelated blocks and connections,
wherein said blocks represent elements comprising electrical circuits, electromechanical devices, and measurement devices, and
wherein the relationships between said blocks and said connections in said model are read-only with respect to an end user;
an input module:
stored on said computer-readable medium, and
operable on a computer to allow an end user to specify at least one characteristic for at least one said block in said model, and
a simulation engine:
stored on said computer-readable medium, and
operable on a computer to
simulate the performance of an electrical power system represented by said model using said specified block characteristics, and
output the results of said simulation

2. The computer program product of claim 1, wherein:
said electrical power system model module comprises a plurality of said models,
said input module allows an end user:
to choose one from among said plurality of models for simulation, and
to specify at least one characteristic for at least one said block in said chosen model; and
said simulation engine is operable on a computer to simulate the performance of an electrical power system represented by said chosen model using said specified block characteristics.

3. The computer program product of claim 1, wherein
said input module is further operable on a computer to allow a user:
to indicate a set of said specified characteristics as a saved electrical power system model configuration; and
to indicate a said saved configuration for simulation
said simulation engine is operable on a computer to simulate the performance of an electrical power system represented by said model using said saved configuration of specified characteristics.

4. The computer program product of claim 2, wherein
said input module is further operable on a computer to allow a user:
to indicate one of said models and one set of said specified characteristics as a saved electrical power system model configuration; and
to indicate a said saved configuration for simulation
said simulation engine is operable on a computer to simulate the performance of an electrical power system represented by said saved configuration.

5. In a computer system, a computer-implemented, end-user assisted method for evaluating the performance of an electrical power system, said method comprising:
defining at least one electrical power system model in a computer, each said model comprising:
interrelated blocks and connections,
wherein said blocks represent elements comprising electrical circuits, electromechanical devices, and measurement devices, and
wherein the relationships between said blocks and said connections in said model are read-only with respect to an end user;
prompting an end user to set at least one parameter for at least one said block;
obtaining said settings;
simulating the operation of said model within said set parameters;
outputting the results of said simulation.

6. The method of claim 5 further comprising
prompting an end user to select one said at least one model; and
obtaining said selection.

7. The method of claim 5 further comprising:
prompting an end user to save said settings; and
obtaining direction from an end user to save said settings

8. The method of claim 5 wherein said at least one electrical power system model comprises:
a source-and-grid model;
a source-and-load model; and
a source-grid-and-load model.
